(19) United States
(12) Patent Application Publication
(10) Pub. No.: US 2026/0364711 A1
(43) Pub. Date: Nov. 19, 2026

(54) MEASUREMENT DEVICE, MEASUREMENT METHOD, AND PROCESSING DEVICE

(71) Applicant: HAMAMATSU PHOTONICS K.K., Hamamatsu-shi, Shizuoka (JP)

(72) Inventors: Takeshi WATARI, Hamamatsu-shi, Shizuoka (JP); Yuta KINE, Hamamatsu-shi, Shizuoka (JP); Takashi KURITA, Hamamatsu-shi, Shizuoka (JP); Koichi SAKAI, Hamamatsu-shi, Shizuoka (JP); Masateru KURATA, Hamamatsu-shi, Shizuoka (JP)

(73) Assignee: HAMAMATSU PHOTONICS K.K., Hamamatsu-shi, Shizuoka (JP)

(21) Appl. No.: 19/475,921

(22) PCT Filed: Dec. 7, 2023
(86) PCT No.: PCT/JP2023/043915

§ 371 Date: Oct. 16, 2025

(30) Foreign Application Priority Data
Apr. 20, 2023 (JP) 2023-069288

(51) Int. Cl. B23K 26/03; B23K 26/352; G01B 11/30

(52) U.S. Cl. CPC B23K 26/032; B23K 26/3576; G01B 11/303

(57) ABSTRACT

A measurement device that measures the surface roughness of an object S, and includes an off-axis parabolic mirror element including a first surface, a second surface configured with a concave parabolic mirror surface and positioned on a side opposite to the first surface, and a through hole connecting the first surface and the second surface. The off-axis parabolic mirror element is disposed such that inspection laser light Ld from an inspection light source travels to the object S through the through hole from the first surface side, regular reflection light Lr having passed through the through hole from the second surface side travels to the first detection unit, and the scattered light Ls reflected by the second surface travels to the second detection unit.

### TECHNICAL FIELD

The present disclosure relates to a measurement device, a measurement method, and a processing device.

### BACKGROUND ART

In recent years, laser polishing processing in which the surface of an object is smoothed by irradiating it with laser light has become known. In laser polishing processing, the surface of the object is smoothed by melting and rearranging or ablating a surface material with laser light. Compared to polishing processing using an abrasive in the related art, laser polishing processing has advantages of being able to process any area of an object with a complex shape, minimizing changes in the shape of the object before and after processing, and not generating polishing debris, and further development of the technology is desired.

In laser polishing processing, from the perspective of evaluating and managing the processing quality, it is essential to measure the surface roughness of an object during processing, similar to polishing processing using an abrasive in the related art. In the related art, the surface roughness of an object has mainly been measured offline, using a microscope or the like, but this method has technical issues such as a lack of real-time measurement capability and a large amount of data required for measurement.

As an alternative to a microscope, there is a method of measuring the surface condition of an object using light, for example, using a surface defect detection device disclosed in Patent Literature 1. In the detection device of the related art, an inspection laser beam is obliquely incident on the surface of an object, and scattered light and regular reflection light from the surface of the object are measured by a light receiving element. Defects on the surface of the object are then detected on the basis of a ratio of the intensity of the scattered light to the intensity of the regular reflection light.

### CITATION LIST

### Patent Literature

[Patent Literature 1] Japanese Unexamined Patent Application No. H11-230912

### SUMMARY OF INVENTION

### Technical Problem

However, when a detection device such as the above-mentioned device disclosed in Patent Literature 1 is applied to measurement of surface roughness of an object in laser polishing processing, fundamental issues include anisotropy of scattered light intensity and a decrease in scattered light intensity on smooth surfaces. Regarding the former case, the anisotropy of the scattered light can affect measurement on surfaces with directional roughness such as polished surfaces. Regarding the latter case, when a smooth surface that is close to a mirror surface is measured, the scattered light intensity becomes weak, resulting in a decrease in an SN ratio of a measurement signal.

Furthermore, when attempting to apply a detection device such as the above-mentioned detection device disclosed in Patent Literature 1 to real-time measurement of surface roughness in a processing device, it is considered that light emission from plasma generated on the surface of the object by irradiation with processing laser light becomes measurement noise. Furthermore, in the above-mentioned detection device disclosed in Patent Literature 1, scattered light is reflected in all directions from an irradiation position of inspection laser light, and thus it is also considered that scattered light is detected as a noise component by a light receiving unit for regular reflection light.

The present disclosure has been made to solve the above-mentioned problems, and an object thereof is to provide a measurement device, a measurement method, and a processing device using the same which are suitable for real-time measurement of surface roughness of an object in laser polishing processing.

### Solution to Problem

A measurement device according to one aspect of the present disclosure is a measurement device that measures surface roughness of an object, the measurement device including an inspection light source that outputs inspection laser light to a surface of the object, a first detection unit that detects regular reflection light of the inspection laser light from a measurement point on the surface of the object, a second detection unit that detects scattered light of the inspection laser light from the measurement point on the surface of the object, and an off-axis parabolic mirror element that includes a first surface, a second surface configured with a concave parabolic mirror surface and positioned on a side opposite to the first surface, and a through hole connecting the first surface and the second surface, in which the off-axis parabolic mirror element is disposed such that the inspection laser light from the inspection light source travels from the first surface side through the through hole to the object, the regular reflection light having passed through the through hole from the second surface side travels to the first detection unit, and the scattered light reflected by the second surface travels to the second detection unit.

In the measurement device, the detection of regular reflection light by the first detection unit and the detection of scattered light by the second detection unit can be performed simultaneously by the arrangement of the off-axis parabolic mirror element. The scattered light generated on the surface of the object travels to the second detection unit at a certain solid angle via the second surface of the off-axis parabolic mirror element, which is a concave parabolic mirror surface. Thus, even when the surface of the object is a polished surface and the scattered light is anisotropic, or even when the surface of the object is a smooth surface and the scattered light is weak, the scattered light can be detected with sufficient intensity in the second detection unit. Furthermore, in the measurement device, it is possible to prevent light other than the regular reflection light from traveling to the first detection unit by the through hole of the off-axis parabolic mirror element functioning as an aperture that transmits only the regular reflection light, and it is possible to prevent the plasma light emission generated on the surface of the object by irradiation with the processing laser light from traveling to the second detection unit together with the scattered light by spatially or temporally shifting the scattered light reflected by the second surface with respect to the processing laser light. Thus, the measurement device can suitably perform real-time measurement of the surface roughness of the object in laser polishing processing.

The measurement device may further include a calculation unit that calculates a surface roughness of the object on the basis of a ratio between an intensity of the regular reflection light detected by the first detection unit and an intensity of the scattered light detected by the second detection unit. In this case, it is possible to eliminate the influence of fluctuations in the output of the inspection laser light when calculating the surface roughness of the object. Thus, the measurement accuracy of the surface roughness is improved.

The off-axis parabolic mirror element may be disposed such that the inspection laser light from the inspection light source travels perpendicular to the surface of the object through the through hole from the first surface side. When the inspection laser light travels obliquely to the surface of the object, it is considered that, when the height of the object is shifted, the optical path of the regular reflection light is shifted significantly and no longer travels to the first detection unit. By disposing the off-axis parabolic mirror element so that the inspection laser light travels perpendicular to the surface of the object, the optical path of the regular reflection light is maintained even when the height of the object is shifted, and thus the measurement accuracy of the surface roughness can be ensured.

The through hole may become gradually narrower from the first surface side toward the second surface side. Thereby, the function of the through hole as an aperture is enhanced, and it is possible to more reliably prevent the plasma light emission caused by the scattered light or the processing laser light from traveling to the first detection unit. Thus, the measurement accuracy of the surface roughness is further improved.

The measurement device may further include a condenser lens that is disposed in an optical path of the scattered light between the second surface and the second detection unit. Thereby, it is possible to further increase the intensity of detection of the scattered light which is performed by the second detection unit. Thus, the measurement accuracy of the surface roughness is further improved.

The measurement device may further includes a half mirror that shares a portion of an optical path of the inspection laser light between the inspection light source and the first surface, and a portion of an optical path of the regular reflection light between the first surface and the first detection unit. In this case, a reduction in the size of the device is achieved by sharing a part of the optical path of the inspection laser light and a part of the optical path of the regular reflection light.

The measurement device may further include an adjustment mechanism that relatively adjusts a positional relationship between the object and the off-axis parabolic mirror element in a traveling direction of the inspection laser light directed toward the object through the through hole from the first surface side. Such an adjustment mechanism makes it easy to align the object and the off-axis parabolic mirror element.

The adjustment mechanism may be configured with a holding unit that holds the off-axis parabolic mirror element movably in a traveling direction of the inspection laser light directed toward the object through the through hole from the first surface side. Thereby, even when objects having different heights are measured, a distance between the off-axis parabolic mirror element and the surface of the object can be easily adjusted to the focal length of the second surface of the off-axis parabolic mirror element, which is a concave parabolic mirror surface.

The adjustment mechanism may be configured with a stage that holds the object movably in a traveling direction of the inspection laser light directed toward the object through the through hole from the first surface side. Thereby, even when objects having different heights are measured, a distance between the off-axis parabolic mirror element and the surface of the object can be easily adjusted to the focal length of the second surface of the off-axis parabolic mirror element, which is a concave parabolic mirror surface.

The first detection unit and the second detection unit may be configured with a single-channel photodetector. In this case, the only information used for roughness measurement is the intensity signals of the regular reflection light and scattered light. Thus, the amount of data to be handled can be reduced compared to when roughness measurement is performed on the basis of two-dimensional image processing, and a processing speed can be increased.

A measurement method according to one aspect of the present disclosure is a measurement method for measuring surface roughness of an object, the measurement method including an output step of outputting inspection laser light to a surface of the object, a detection step of detecting regular reflection light of the inspection laser light from a measurement point on the surface of the object by a first detection unit and detecting scattered light of the inspection laser light from the measurement point on the surface of the object by a second detection unit, in which, in the output step and the detection step, an off-axis parabolic mirror element including a first surface, a second surface configured with a concave parabolic mirror surface and positioned on a side opposite to the first surface, and a through hole connecting the first surface and the second surface is used, and the off-axis parabolic mirror element is disposed such that the inspection laser light travels from the first surface side through the through hole to the object, the regular reflection light having passed through the through hole from the second surface side travels to the first detection unit, and the scattered light reflected by the second surface travels to the second detection unit.

In this measurement method, the detection of regular reflection light by the first detection unit and the detection of scattered light by the second detection unit can be performed simultaneously by the arrangement of the off-axis parabolic mirror element. The scattered light generated on the surface of the object travels to the second detection unit at a certain solid angle via the second surface of the off-axis parabolic mirror element, which is a concave parabolic mirror surface. Thus, even when the surface of the object is a polished surface and the scattered light is anisotropic, or even when the surface of the object is a smooth surface and the scattered light is weak, the scattered light can be detected with sufficient intensity in the second detection unit. Furthermore, in the measurement method, it is possible to prevent light other than the regular reflection light from traveling to the first detection unit by the through hole of the off-axis parabolic mirror element functioning as an aperture that transmits only the regular reflection light, and it is possible to prevent the plasma light emission generated on the surface of the object by irradiation with the processing laser light from traveling to the second detection unit together with the scattered light by spatially or temporally shifting the scattered light reflected by the second surface with respect to the processing laser light. Thus, the measurement device can suitably perform real-time measurement of the surface roughness of the object in laser polishing processing.

A processing device according to one aspect of the present disclosure is a processing device that processes a surface of an object, the processing device including a processing light source that outputs processing laser light to the surface of the object, and the measurement device. The measurement device can suitably perform real-time measurement of the surface roughness of the object in laser polishing processing by using the above-mentioned measurement device.

The measurement device may further include a calculation unit that calculates a surface roughness of the object on the basis of a ratio between an intensity of the regular reflection light detected by the first detection unit and an intensity of the scattered light detected by the second detection unit. In this case, it is possible to eliminate the influence of fluctuations in the output of the inspection laser light when calculating the surface roughness of the object. Thus, the measurement accuracy of the surface roughness is improved.

The processing device may further include a stage that holds the object movably in a traveling direction of the inspection laser light directed toward the object through the through hole from the first surface side and in an in-plane direction of the surface of the object. In this case, it is possible to scan the surface of the object with the processing laser light and the inspection laser light using the stage. Thus, it is possible to continuously measure the surface roughness of the object along a processing area and to improve the workability of processing.

An irradiation position of the inspection laser light may be shifted from an irradiation position of the processing laser light on the surface of the object. In this case, it is possible to spatially separate the optical path of the scattered light that is reflected by the second surface of the off-axis parabolic mirror element and travels to the second detection unit, and the optical path of the plasma light emission that is similarly reflected by the second surface of the off-axis parabolic mirror element and travels to the second detection unit. Since the optical paths of the scattered light and the plasma light emission are spatially separated from each other, the plasma light emission is prevented from being incident on the second detection unit, and it is possible to prevent the plasma light emission from affecting the measurement of the surface roughness of the object.

An aperture that transmits only the scattered light may be disposed in an optical path of the scattered light between the second surface and the second detection unit. In this case, light other than the scattered light can be blocked by the aperture, and thus the plasma light emission caused by the processing laser light can be prevented from traveling to the second detection unit. Thus, it is possible to more suitably perform real-time measurement of the surface roughness of the object.

The processing device may further include a control unit that controls the processing light source and the inspection light source so that the surface of the object is irradiated with the processing laser light and the inspection laser light during different output periods. In this case, the scattered light reflected from the second surface and directed toward the second detection unit and the plasma light emission which is similarly reflected by the second surface and travels to the second detection unit are temporally shifted from each other, and thus it is possible to prevent the plasma light emission from affecting the detection of the scattered light by the second detection unit. Thus, it is possible to more suitably perform real-time measurement of the surface roughness of the object.

The calculation unit may calculate a surface roughness of the object on the basis of a ratio between an intensity of the regular reflection light detected by the first detection unit during a period in which the surface of the object is not irradiated with the processing laser light and an intensity of the scattered light detected by the second detection unit during the same period. In this case, it is possible to eliminate the influence of plasma light emission caused by the processing laser light when calculating the surface roughness of the object. Thus, the measurement accuracy of the surface roughness is improved.

### Advantageous Effects of Invention

According to the present disclosure, it is possible to suitably perform real-time measurement of surface roughness of an object in laser polishing processing.

### BRIEF DESCRIPTION OF DRAWINGS

FIG. 1 is a schematic diagram showing the configuration of a measurement device according to an embodiment of the present disclosure.

FIG. 2 is a diagram showing an example of calibration curve data stored in a calculation unit.

FIG. 3 is a diagram showing an enlarged view of the configuration of an off-axis parabolic mirror element.

FIG. 4 is a flowchart showing an example of a measurement method according to an embodiment of the present disclosure.

FIG. 5 is a schematic diagram showing an example of the configuration of a processing device including the measurement device shown in FIG. 1.

FIG. 6 is a schematic diagram showing another example of the configuration of a processing device including the measurement device shown in FIG. 1.

FIG. 7 is a diagram showing an output timing of processing laser light and inspection laser light in the processing device shown in FIG. 6.

FIG. 8 is a schematic diagram showing still another example of the configuration of a processing device including the measurement device shown in FIG. 1.

### DESCRIPTION OF EMBODIMENTS

Hereinafter, preferred embodiments of a measurement device, a measurement method, and a processing device according to one aspect of the present disclosure will be described in detail with reference to the drawings.

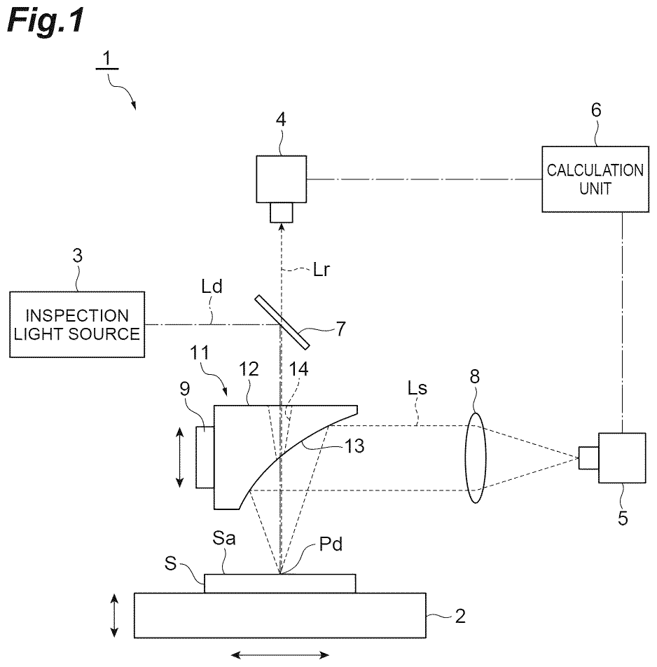

FIG. 1 is a schematic diagram showing the configuration of a measurement device according to an embodiment of the present disclosure. A measurement device 1 shown in FIG. 1 is configured as a device that measures roughness of a surface Sa of an object S. The object S is not particularly limited, but may be, for example, various metal materials such as copper, aluminum, and iron, or a semiconductor wafer.

As shown in FIG. 1, the measurement device 1 is configured to include a stage 2 on which the object S is placed, an inspection light source 3 that outputs inspection laser light Ld, a first detection unit 4 that detects regular reflection light Lr of the inspection laser light Ld, a second detection unit 5 that detects scattered light Ls of the inspection laser light Ld, and a calculation unit 6 that calculates the surface roughness of the object S on the basis of detection results of the regular reflection light Lr and the scattered light Ls. An off-axis parabolic mirror element 11 is disposed in optical paths of the inspection laser light Ld, the regular reflection light Lr, and the scattered light Ls.

The stage 2 has a placement area in which the object S is placed. The object S is placed on the stage 2 so that the surface Sa to be measured faces in the traveling direction of the inspection laser light Ld. The stage 2 functions as an adjustment mechanism that relatively adjusts a positional relationship between the object S and the off-axis parabolic mirror element 11 in the traveling direction of the inspection laser light Ld that is directed toward the object S through a through hole 14 from the first surface 12 side of the off-axis parabolic mirror element 11, which will be described later. In this embodiment, the stage 2 is configured, for example, by a three-axis movable stage. The stage 2 is movable in the traveling direction of the inspection laser light Ld to align the off-axis parabolic mirror element 11 and the object S in the height direction. The stage 2 is also movable in the in-plane direction of the surface Sa of the object S for the purpose of scanning measurement points of the inspection laser light Ld on the surface Sa of the object S.

An inspection light source 3 outputs the inspection laser light Ld to the object S. As the inspection light source 3, for example, a HeNe laser can be used. The inspection laser light Ld is, for example, CW light. As an example, the wavelength of the inspection laser light Ld is 632.8 nm, an output power is 1 mW, and a beam diameter is 500 μm. The inspection laser light Ld that is output from the inspection light source 3 is reflected by a half mirror 7 and travels perpendicular to the surface Sa of the object S placed on the stage 2. It is also possible to use pulsed light instead of CW light as the inspection laser light Ld. When pulsed light is used, it is preferable to set a repetition frequency of the inspection laser light Ld to be lower than a repetition frequency of processing laser light Lw so as not to overlap plasma light emission from a processing point (for example, an irradiation position Pw of the processing laser light Lw to be described below).

The first detection unit 4 detects regular reflection light Lr of the inspection laser light Ld from a measurement point on the surface Sa of the object S. The first detection unit 4 generates information indicating a detection result of the regular reflection light Lr, and outputs the information to the calculation unit 6. In this embodiment, the first detection unit 4 is configured with, for example, a single-channel photodetector, and outputs an intensity signal (current value signal) whose magnitude is proportional to the detection result of the regular reflection light Lr to the calculation unit 6. As the photodetector, for example, a photodiode, an avalanche photodiode, a photomultiplier tube, and the like can be used.

The regular reflection light Lr is light reflected from a reflecting surface at an angle of incidence and an angle of reflection that are equal. In this embodiment, the inspection laser light Ld is incident perpendicularly on the surface Sa of the object S. Thus, the regular reflection light Lr is light that is reflected perpendicularly from an irradiation position (measurement point) Pd of the inspection laser light Ld on the surface Sa of the object S. The intensity of the regular reflection light Lr tends to become greater as the surface roughness of the measurement point becomes smaller.

In this embodiment, the light receiving surface of the first detection unit 4 has a rectangular shape of, for example, 3 mm×3 mm. The size of the light receiving surface may be equal to or greater than an opening width on a first surface 12 side or an opening width on a second surface 13 side of the through hole 14 of the off-axis parabolic mirror element 11 to be described below. In this case, even when the optical axis of the regular reflection light Lr is shifted due to vibrations or alignment errors during the use of the measurement device 1, it is possible to ensure that the regular reflection light Lr is incident on the light receiving surface of the first detection unit 4.

The second detection unit 5 detects scattered light Ls of the inspection laser light Ld from a measurement point on the surface Sa of the object S. The second detection unit 5 generates information indicating a detection result of the scattered light Ls and outputs the information to the calculation unit 6. In this embodiment, the second detection unit 5 is configured with, for example, a single-channel photodetector, and outputs a current value signal having a magnitude proportional to the detection result of the scattered light Ls to the calculation unit 6. Similarly to the first detection unit 4, for example, a photodiode, an avalanche photodiode, a photomultiplier tube, and the like can be used as the photodetector.

The scattered light Ls is light that reflects over a wide range from a reflecting surface due to the surface roughness of the reflecting surface. The scattered light Ls diffuses in all directions starting from the irradiation position (measurement point) Pd of the inspection laser light Ld on the surface Sa of the object S. When the surface Sa of the object S is, for example, a polished surface and the surface roughness has directionality, the scattered light Ls may be reflected from the measurement point with anisotropy according to the direction of polishing. The scattered light Ls tends to become smaller as the surface roughness of the measurement point decreases, and when the surface Sa of the object S is a smooth surface close to a mirror surface, the light may become weak in intensity.

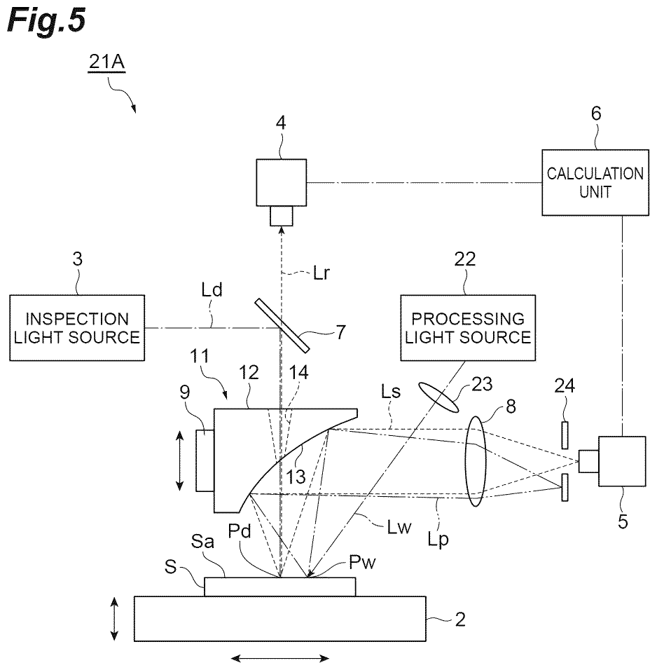

In this embodiment, the light receiving surface of the second detection unit 5 has a rectangular shape of, for example, 3 mm×3 mm. The size of the light receiving surface may be equal to or greater than an opening width of a pinhole (or an opening diameter when the pinhole is circular) formed in an aperture 24 (see FIG. 5) to be described below. In this case, even when the optical axis of the scattered light Ls is shifted due to vibrations or alignment errors during the use of the measurement device 1, it is possible to ensure that the scattered light Ls is incident on the light receiving surface of the second detection unit 5.

The calculation unit 6 calculates the surface roughness of the object S. The calculation unit 6 is physically configured with a computer including a processor such as a CPU, and storage media such as a RAM and a ROM. The computer may be a smartphone or tablet terminal equipped with an integrated display until and input unit. The computer may be configured with a microcomputer, a field-programmable gate array (FPGA), or the like.

The calculation unit 6 receives detection result information from the first detection unit 4 and detection result information from the second detection unit 5, and calculates the surface roughness of the object S on the basis of a ratio between the intensity of the regular reflection light Lr and the intensity of the scattered light Ls obtained from these pieces of detection result information. The calculation unit 6 holds, for example, calibration curve data for each object S in advance when calculating the surface roughness based on the ratio between the intensity of the regular reflection light Lr and the intensity of the scattered light Ls.

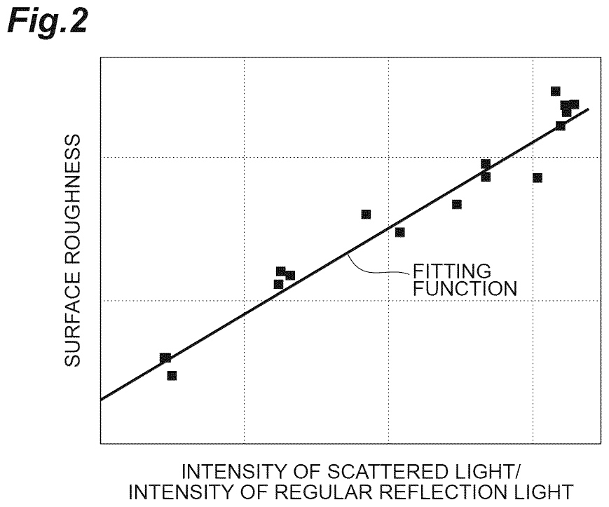

FIG. 2 shows an example of calibration curve data stored in the calculation unit. In the example shown in the drawing, the horizontal axis represents a ratio of the intensity of scattered light to the intensity of regular reflection light, and the vertical axis represents surface roughness. In this calibration curve data, calculation results of the ratio of the intensity of scattered light to the intensity of regular reflection light for a plurality of object samples with known surface roughness are plotted, and a fitting function based on the calculation results is generated.

The calculation unit 6 substitutes the ratio between the intensity of the regular reflection light Lr and the intensity of the scattered light Ls into the fitting function with reference to the calibration curve data to calculate measurement results for the surface roughness at the measurement point on the surface Sa of the object S. The calculation unit 6 may display the measurement results for the surface roughness on a display unit such as a display, or may store a history of the measurement results for each measurement point on the object S in a storage unit.

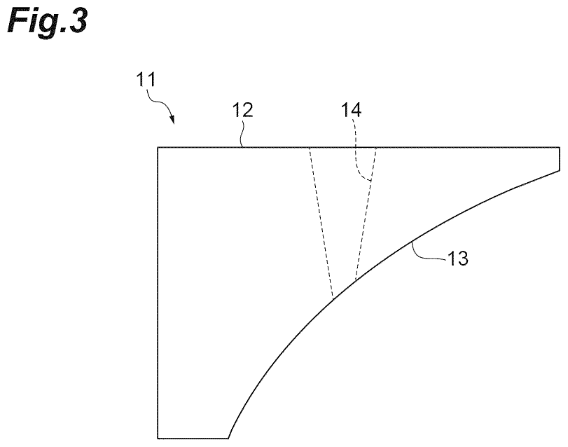

Next, the off-axis parabolic mirror element 11 will be described. FIG. 3 is an enlarged view showing the configuration of the off-axis parabolic mirror element. The off-axis parabolic mirror element (off-axis parabolic mirror element) 11 is an element that reflects light from measurement point Pd as parallel light using a parabolic mirror surface. Here, an off-axis (off-axis) angle is 90°, but this angle can be set to any angle such as 30°, 45°, or 60°.

As shown in FIG. 3, the off-axis parabolic mirror element 11 includes the first surface 12, a second surface 13 located on the opposite side to the first surface 12, and the through hole 14 connecting the first surface 12 and the second surface 13. The first surface 12 is a flat non-mirror surface, whereas the second surface 13 is a concave parabolic mirror surface. In FIG. 3, the off-axis parabolic mirror element 11 is shown from the side, but the actual second surface 13 is a three-dimensional concave parabolic mirror surface. The width of the second surface 13 along the extension direction of the through hole 14 is, for example, 50 mm.

The through hole 14 connects a space on the first surface 12 side with a space on the second surface 13 side. The through hole 14 has, for example, a circular cross section. From the viewpoint of making the through hole 14 function as an aperture for the regular reflection light Lr, the through hole 14 becomes gradually narrower from the first surface 12 side toward the second surface 13 side. With such a configuration, the inspection laser light Ld can be reliably incident on the through hole 14 on the first surface 12 side, while the scattered light Ls and plasma light associated with processing can be suitably cut off on the second surface 13 side.

From the viewpoint of making the through hole 14 function as an aperture for the regular reflection light Lr, it is preferable that the opening width of the through hole 14 on the first surface 12 side and the opening width on the second surface 13 side are 10 mm or less. Here, the opening of the through hole 14 on the first surface 12 side is, for example, a circle with a diameter of 8 mm. The opening of the through hole 14 on the second surface 13 side is, for example, a circle with a diameter of 3 mm. Note that the cross-sectional shape (opening shape) of the through hole 14 is not limited to a circle, and may be an ellipse, a rectangle, a triangle, or another polygonal shape.

As shown in FIG. 1, the off-axis parabolic mirror element 11 is disposed such that the inspection laser light Ld from the inspection light source 3 travels to the object S through the through hole 14 from the first surface 12 side, the regular reflection light Lr having passed through the through hole 14 from the second surface 13 side travels to the first detection unit 4, and the scattered light Ls reflected by the second surface 13 travels to the second detection unit 5. The scattered light Ls is collimated when reflected by the second surface 13, which is a concave parabolic mirror surface, and travels to the second detection unit 5 in the form of parallel light.

Further, the off-axis parabolic mirror element 11 is disposed such that the focal point of the second surface 13, which is a concave parabolic mirror surface, coincides with the measurement point Pd of the inspection laser light Ld. A distance from the measurement point Pd to the center of the opening on the second surface 13 side of the through hole 14 of the off-axis parabolic mirror element 11 is, for example, 50 mm. From the viewpoint of preventing damage to the off-axis parabolic mirror element 11 due to debris generated during irradiation with the processing laser light Lw and plasma, it is preferable that the distance from the measurement point Pd to the center of the opening on the second surface 13 side of the through hole 14 of the off-axis parabolic mirror element 11 is 10 mm or more. From the viewpoint of miniaturizing the measurement device 1 and shortening the optical path lengths of the inspection laser light Ld, the regular reflection light Lr, and the scattered light Ls to prevent attenuation of a signal amount, it is preferable that the distance is 100 mm or less.

In this embodiment, the off-axis parabolic mirror element 11 is disposed such that the parabolic mirror surface formed on the second surface 13 covers a solid angle of approximately 10% with respect to a hemisphere centered on the measurement point Pd and defined by the surface Sa of the object S. From the viewpoint of acquiring a scattered light signal with sufficient intensity in the second detection unit 5, it is preferable that the parabolic mirror surface covers a solid angle of 5% or more with respect to the hemisphere.

The solid angle covered by the parabolic mirror surface can be controlled by adjusting the shape of the parabolic mirror surface formed on the second surface 13 and the distance from the measurement point Pd to the center of the opening on the second surface 13 side of the through hole 14 of the off-axis parabolic mirror element 11. Specifically, it is possible to increase the solid angle covered by the parabolic mirror surface by increasing the area of the parabolic mirror surface, shortening the distance from the measurement point Pd to the center of the opening on the second surface 13 side of the through hole 14 of the off-axis parabolic mirror element 11, or by using both of these together.

By disposing the off-axis parabolic mirror element 11 in this manner, in this embodiment, as shown in FIG. 1, the inspection laser light Ld reflected by the half mirror 7 travels perpendicularly to the surface Sa of the object S through the through hole 14 from the first surface 12 side. The regular reflection light Lr at the measurement point of the inspection laser light Ld passes through the through hole 14 from the second surface 13 side coaxially with and in the opposite direction to the inspection laser light Ld, passes through the half mirror 7, and is then incident on the first detection unit 4. Between the half mirror 7 and the surface Sa of the object S, the optical path of the inspection laser light Ld traveling to the object S and the optical path of the regular reflection light Lr directed toward the first detection unit 4 from the object S are shared.

Although not shown in the drawing, a condenser lens may be disposed in the optical path of the regular reflection light Lr between the first surface 12 and the first detection unit 4. In this case, the regular reflection light Lr having passed through the through hole 14 from the second surface 13 side is condensed by the condenser lens and is incident on the first detection unit 4. For example, a plurality of condenser lenses may be disposed in the optical path of the regular reflection light Lr between the first surface 12 and the first detection unit 4. Specifically, a first condenser lens for the purpose of condensing the regular reflection light Lr at the light receiving surface of the first detection unit 4 may be disposed between the first detection unit 4 and the half mirror 7, and a second condenser lens for the purpose of condensing the inspection laser light Ld on the surface Sa of the object S may be disposed between the half mirror 7 and the first surface 12. According to such a configuration, the regular reflection light Lr and the inspection laser light Ld can be more suitably condensed by the first condenser lens and the second condenser lens corresponding to the regular reflection light Lr and the inspection laser light Ld, respectively. Note that a configuration in which only one of the first condenser lens and the second condenser lens is disposed may also be used.

The scattered light Ls at the measurement point of the inspection laser light Ld is reflected by the second surface 13, which is a concave parabolic mirror surface, at a solid angle formed by the second surface 13, and is incident on the second detection unit 5. In the example of FIG. 1, a condenser lens 8 is disposed in the optical path of the scattered light Ls between the second surface 13 and the second detection unit 5. The scattered light Ls is collimated by the second surface 13, which is a concave parabolic mirror surface, is incident on the condenser lens 8 as parallel light, is condensed by the condenser lens 8, and is incident on the second detection unit 5.

In the example of FIG. 1, the off-axis parabolic mirror element 11 is held by a holding unit 9. The holding unit 9 functions as an adjustment mechanism that relatively adjusts a positional relationship between the object S and the off-axis parabolic mirror element 11 in the traveling direction of the inspection laser light Ld directed toward the object S through the through hole 14 from the first surface 12 side of the off-axis parabolic mirror element 11, similar to the stage 2. The holding unit 9 holds the off-axis parabolic mirror element 11 movably in the traveling direction of the inspection laser light Ld directed toward the object S through the through hole 14 from the first surface 12 side, in order to align the off-axis parabolic mirror element 11 and the object S in the height direction. The holding unit 9 may be configured to hold the off-axis parabolic mirror element 11, the condenser lens 8, and the second detection unit 5 movably in the traveling direction of the inspection laser light Ld directed toward the object S through the through hole 14 from the first surface 12 side, while maintaining the positional relationship therebetween.

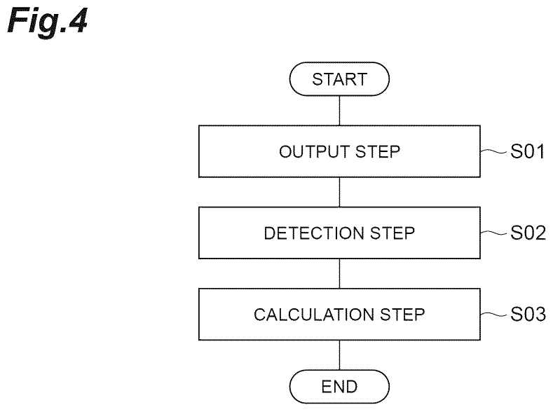

Next, a measurement method according to an embodiment of the present disclosure will be described. FIG. 4 is a flowchart showing an example of a measurement method according to an embodiment of the present disclosure. As shown in FIG. 4, the measurement method includes an output step (step S01), a detection step (step S02), and a calculation step (step S03).

The output step is a step of outputting the inspection laser light Ld toward the surface Sa of the object S. The detection step is a step of detecting the regular reflection light Lr of the inspection laser light Ld from a measurement point on the surface Sa of the object S by the first detection unit 4, and detecting the scattered light Ls of the inspection laser light Ld from the measurement point by the second detection unit 5. The calculation step is a step of calculating the surface roughness of the object S on the basis of a ratio between the intensity of the regular reflection light Lr detected in the detection step and the intensity of the scattered light Ls detected by the second detection unit 5.

In the output step and detection step, the off-axis parabolic mirror element 11 described above is used. In the output step, the inspection laser light Ld is caused to travel from the first surface 12 side through the through hole 14 to the object S. In the detection step, the regular reflection light Lr that has passed through the through hole 14 from the second surface 13 side is caused to travel to the first detection unit 4, and the scattered light Ls reflected by the second surface 13 is caused to travel to the second detection unit 5. In this embodiment, in the output step, the stage 2 is driven in the in-plane direction of the surface Sa of the object S, and the detection step and calculation step are repeatedly performed while scanning the measurement point using the inspection laser light Ld over the surface Sa of the object S. This makes it possible to measure the surface roughness in a desired area of the surface Sa of the object S.

Next, a processing device according to an embodiment of the present disclosure will be described. FIG. 5 is a schematic diagram showing an example of the configuration of a processing device. A processing device 21A shown in FIG. 5 is configured as a device that performs laser polishing processing on the surface Sa of the object S and also performs real-time measurement of the surface roughness of the object S in a polishing area.

As shown in FIG. 5, the processing device 21A includes a processing light source 22 and the measurement device 1 shown in FIG. 1. The processing light source 22 outputs the processing laser light Lw to the surface Sa of the object S. As the processing light source 22, for example, a YAG laser can be used. The processing laser light Lw is, for example, pulsed light. As an example, the processing laser light Lw has a wavelength of 1064 nm, an output intensity of 5 GW/cm², a beam diameter of 50 μm, and a repetition frequency of 300 kHz. Note that CW light may be used as the processing laser light Lw. In this case, as an example, a fiber laser (wavelength of 1090 nm) with an output power of approximately 100 W can be used.

The processing laser light Lw output from the processing light source 22 is condensed by a condenser lens 23 and travels toward the surface Sa of the object S placed on the stage 2. In the processing device 21A, the stage 2 is moved in the in-plane direction of the surface Sa of the object S, thereby making it possible to scan the irradiation position Pw of the processing laser light Lw and the irradiation position Pd of the inspection laser light Ld over the surface Sa of the object S. This makes it possible to perform laser polishing processing on the surface Sa of the object S and to perform real-time measurement of the surface roughness of the object S in the polishing area.

In this embodiment, first, an arbitrary point on the surface Sa of the object S is irradiated with the inspection laser light Ld, and the calculation unit 6 calculates the surface roughness at the measurement point Pd. After calculating the surface roughness at the measurement point Pd, the stage 2 is moved in the in-plane direction to move the irradiation position Pw of the processing laser light Lw to the position of the measurement point Pd, and processing of that position is performed. In this manner, by simultaneously calculating the surface roughness and processing different points, a throughput is improved.

In the processing device 21A, plasma is generated on the surface Sa of the object S by irradiation with the processing laser light Lw, and it is considered that plasma light emission Lp travels to the first detection unit 4 and the second detection unit 5. The plasma light emission Lp diffuses in all directions starting from the irradiation position (measurement point) Pw of the processing laser light Lw on the surface Sa of the object S. In response to such plasma light emission Lp, in the processing device 21A, the above-mentioned off-axis parabolic mirror element 11 is disposed in the optical paths of the inspection laser light Ld, the regular reflection light Lr, and the scattered light Ls. The through hole 14 of the off-axis parabolic mirror element 11 functions as an aperture that transmits only the regular reflection light Lr toward the first surface 12, and prevents the plasma light emission Lp from traveling to the first detection unit 4.

Furthermore, from the viewpoint of preventing the plasma light emission Lp from traveling to the second detection unit 5, in the processing device 21A, the processing laser light Lw and the inspection laser light Ld that are incident on the surface Sa of the object S are spatially shifted. In the example of FIG. 5, the processing laser light Lw and the inspection laser light Ld are non-coaxial, and the processing laser light Lw travels toward the surface Sa of the object S in an oblique state with respect to the inspection laser light Ld that travels perpendicularly toward the surface Sa of the object S.

On the surface Sa of the object S, the irradiation position Pd of the inspection laser light Ld is shifted from the irradiation position Pw of the processing laser light Lw. It is preferable that the amount of spatial shift between the irradiation positions Pd and Pw is such that the irradiation spot of the processing laser light Lw and the irradiation spot of the inspection laser light Ld do not overlap each other on the surface Sa of the object S. For example, it is preferable that the irradiation position Pw of the processing laser light Lw and the irradiation position Pd of the inspection laser light Ld are separated by a distance approximately twice an irradiation spot diameter of the processing laser light Lw or an irradiation spot diameter of the inspection laser light Ld. As an example, a distance between the irradiation positions Pd and Pw can be approximately 1 mm.

By spatially shifting the irradiation position Pd of the inspection laser light Ld and the irradiation position Pw of the processing laser light Lw, it is possible to spatially separate the optical path of the scattered light Ls that is reflected by the second surface 13 of the off-axis parabolic mirror element 11 and travels to the second detection unit 5 from the optical path of the plasma light emission Lp, as shown in FIG. 5. By spatially separating the optical path of the scattered light Ls from the optical path of the plasma light emission Lp, the plasma light emission Lp is prevented from being incident on the second detection unit 5.

Further, in the processing device 21A, as shown in FIG. 5, the aperture 24 is disposed in the optical path of the scattered light Ls between the second surface 13 and the second detection unit 5. The aperture 24 is configured with, for example, a pinhole. In the example of FIG. 5, the aperture 24 is disposed between the condenser lens 8 and the second detection unit 5. The aperture 24 is disposed to transmit only the scattered light Ls, and blocks the plasma light emission Lp spatially separated from the scattered light Ls before the second detection unit 5. From the viewpoint of allowing only the scattered light Ls to travel to the second detection unit 5 by the aperture 24, it is preferable that the width of the pinhole (an opening diameter when the pinhole is circular) is 1 mm or less. In this embodiment, the pinhole is circular, and its opening diameter is, for example, 0.1 mm.

As described above, in the measurement device 1 and measurement method according to this embodiment, the detection of regular reflection light Lr by the first detection unit 4 and the detection of scattered light Ls by the second detection unit 5 can be performed simultaneously by the arrangement of the off-axis parabolic mirror element 11. The scattered light Ls generated on the surface Sa of the object S travels to the second detection unit 5 at a certain solid angle by the second surface 13 of the off-axis parabolic mirror element 11, which is a concave parabolic mirror surface. Thus, even when the surface Sa of the object S is a polished surface and the scattered light Ls is anisotropic, or even when the surface Sa of the object S is a smooth surface and the scattered light Ls is weak, the scattered light Ls can be detected with sufficient intensity in the second detection unit 5.

Furthermore, in the measurement device 1, it is possible to prevent light other than the regular reflection light Lr from traveling to the first detection unit 4 by the through hole 14 of the off-axis parabolic mirror element 11 functioning as an aperture that transmits only the regular reflection light Lr, and it is possible to prevent the plasma light emission Lp generated on the surface Sa of the object S by irradiation with the processing laser light Lw from traveling to the second detection unit 5 together with the scattered light by spatially or temporally shifting the scattered light Ls reflected by the second surface 13 with respect to the processing laser light Lw. Thus, the measurement device 1 can suitably perform real-time measurement of the surface roughness of the object S in laser polishing processing.

The measurement device 1 includes the calculation unit 6 that calculates the surface roughness of the object S on the basis of a ratio between the intensity of the regular reflection light Lr detected by the first detection unit 4 and the intensity of the scattered light Ls detected by the second detection unit 5. By using such a calculation method, it is possible to eliminate the influence of fluctuations in the output of the inspection laser light Ld when calculating the surface roughness of the object S. Thus, the measurement accuracy of the surface roughness is improved.

In the measurement device 1, the off-axis parabolic mirror element 11 is disposed such that the inspection laser light Ld from the inspection light source 3 travels perpendicular to the surface Sa of the object S through the through hole 14 from the first surface 12 side. When the inspection laser light Ld travels obliquely to the surface Sa of the object S, it is considered that, when the height of the object S is shifted, the optical path of the regular reflection light Lr is shifted significantly and no longer travels to the first detection unit 4. By disposing the off-axis parabolic mirror element 11 so that the inspection laser light Ld travels perpendicular to the surface Sa of the object S, the optical path of the regular reflection light Lr is maintained even when the height of the object S is shifted, and thus the measurement accuracy of the surface roughness can be ensured.

In the measurement device 1, the through hole 14 becomes gradually narrows from the first surface 12 side toward the second surface 13 side. Thereby, the function of the through hole 14 as an aperture is enhanced, and it is possible to more reliably prevent the plasma light emission Lp caused by the scattered light Ls or the processing laser light Lw from traveling to the first detection unit 4. Thus, the measurement accuracy of the surface roughness is further improved.

In the measurement device 1, the condenser lens 8 is disposed in the optical path of the scattered light Ls between the second surface 13 and the second detection unit 5. Thereby, it is possible to further increase the intensity of detection of the scattered light Ls which is performed by the second detection unit 5. Thus, the measurement accuracy of the surface roughness is further improved.

In the measurement device 1, the half mirror 7 is disposed which shares a part of the optical path of the inspection laser light Ld between the inspection light source 3 and the first surface 12, and a part of the optical path of the regular reflection light Lr between the first surface 12 and the first detection unit 4. In this manner, a reduction in the size of the device is achieved by sharing a part of the optical path of the inspection laser light Ld and a part of the optical path of the regular reflection light Lr.

The measurement device 1 includes the holding unit 9 that holds the off-axis parabolic mirror element 11 movably in the traveling direction of the inspection laser light Ld directed toward the object S through the through hole 14 from the first surface 12 side, as an adjustment mechanism for relatively adjusting a positional relationship between the object S and the off-axis parabolic mirror element 11. Thereby, even when objects S having different heights are measured, a distance between the off-axis parabolic mirror element 11 and the surface Sa of the object S can be easily adjusted to the focal length of the second surface 13 of the off-axis parabolic mirror element 11, which is a concave parabolic mirror surface.

The measurement device 1 includes the stage 2 that holds the object S movably in the traveling direction of the inspection laser light Ld that is directed toward the object S through the through hole 14 from the first surface 12 side, as an adjustment mechanism for relatively adjusting a positional relationship between the object S and the off-axis parabolic mirror element 11. Thereby, even when objects S having different heights are measured, a distance between the off-axis parabolic mirror element 11 and the surface Sa of the object S can be easily adjusted to the focal length of the second surface 13 of the off-axis parabolic mirror element 11, which is a concave parabolic mirror surface.

In the measurement device 1, the first detection unit 4 and the second detection unit 5 are configured with a single-channel photodetector. Thereby, the only information used for roughness measurement is the intensity signals (current value signals) of the regular reflection light Lr and scattered light Ls. Thus, the amount of data to be handled can be reduced compared to when roughness measurement is performed on the basis of two-dimensional image processing, and a processing speed can be increased.

Furthermore, by using the above-mentioned measurement device 1, the processing device 21A can suitably perform real-time measurement of the surface roughness of the object S in laser polishing processing. In the processing device 21A, the surface Sa of the object S can be scanned with the processing laser light Lw and the inspection laser light Ld by the above-mentioned stage 2. Thus, it is possible to continuously measure the surface roughness of the object S along a processing area and to improve the workability of processing.

In the processing device 21A, the irradiation position Pd of the inspection laser light Ld is shifted from the irradiation position Pw of the processing laser light Lw on the surface Sa of the object S. Thereby, it is possible to spatially separate the optical path of the scattered light Ls that is reflected by the second surface 13 of the off-axis parabolic mirror element 11 and travels to the second detection unit 5, and the optical path of the plasma light emission Lp that is similarly reflected by the second surface 13 of the off-axis parabolic mirror element 11 and travels to the second detection unit 5. Since the optical paths of the scattered light Ls and the plasma light emission Lp are spatially separated from each other, the plasma light emission Lp is prevented from being incident on the second detection unit 5, and it is possible to prevent the plasma light emission Lp from affecting the measurement of the surface roughness of the object S.

In the processing device 21A, the aperture 24 that transmits only the scattered light Ls is disposed in the optical path of the scattered light Ls between the second surface 13 and the second detection unit 5. In this case, light other than the scattered light Ls can be blocked by the aperture 24, and thus the plasma light emission Lp caused by the processing laser light Lw can be prevented from traveling to the second detection unit 5. Thus, it is possible to more suitably perform real-time measurement of the surface roughness of the object S.

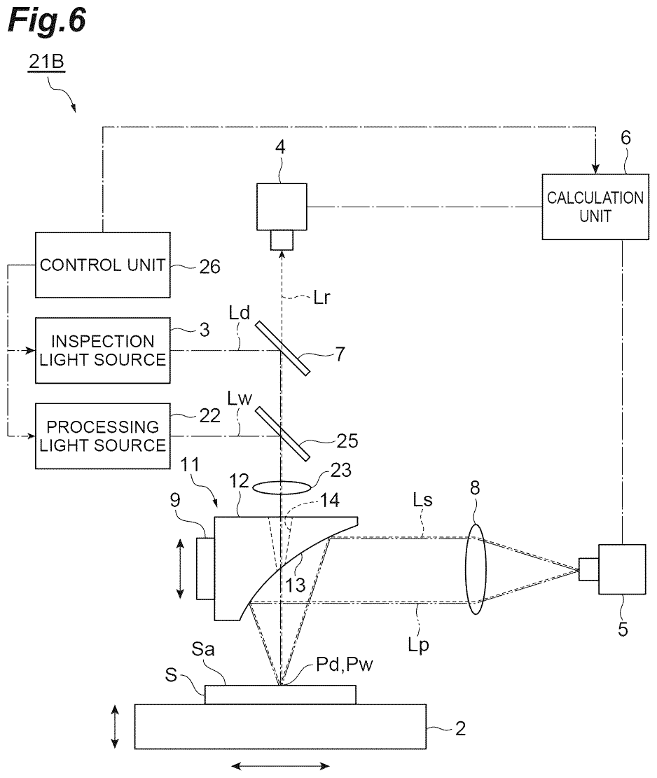

FIG. 6 is a schematic diagram showing another example of the configuration of a processing device. A processing device 21B shown in FIG. 6 differs from the processing device 21A shown in FIG. 5 in that the processing laser light Lw and the inspection laser light Ld directed toward the object S are coaxial. In the example of FIG. 6, the processing laser light Lw output from the processing light source 22 is reflected by a dichroic mirror 25 and condensed by the condenser lens 23. Thereafter, the processing laser light Lw passes through the through hole 14 of the off-axis parabolic mirror element 11 from the first surface 12 side and travels toward the surface Sa of the object S placed on the stage 2.

The inspection laser light Ld output from the inspection light source 3 is reflected by the half mirror 7, passes through the dichroic mirror 25, and becomes coaxial with the processing laser light Lw. Thereafter, the inspection laser light Ld is condensed by the condenser lens 23 together with the processing laser light Lw, passes through the through hole 14 of the off-axis parabolic mirror element 11 from the first surface 12 side, and travels toward the surface Sa of the object S placed on the stage 2. The regular reflection light Lr at the measurement point of the inspection laser light Ld passes through the through hole 14 from the second surface 13 side coaxially with and in the opposite direction to the processing laser light Lw and the inspection laser light Ld, passes through the dichroic mirror 25 and the half mirror 7, and is then incident on the first detection unit 4.

In the processing device 21B, the irradiation position Pd of the inspection laser light Ld and the irradiation position Pw of the processing laser light Lw coincide with each other, while the processing laser light Lw and the inspection laser light Ld incident on the surface Sa of the object S are temporally shifted. In the example of FIG. 6, the processing device 21B includes a control unit 26 that controls the processing light source 22 and the inspection light source 3 so that the surface Sa of the object S is irradiated with the processing laser light Lw and the inspection laser light Ld during different periods.

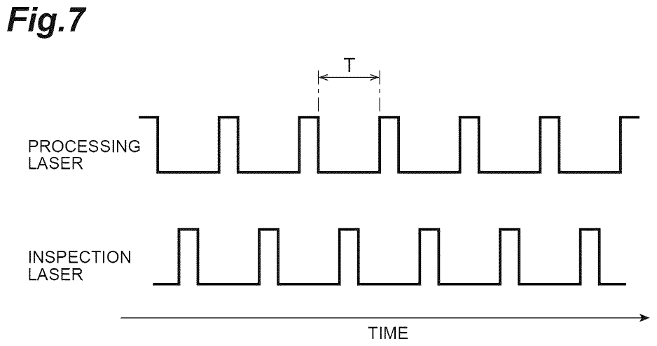

The control unit 26 is configured with a mechanical shutter that shapes the inspection laser light Ld, which is, for example, CW light, into a pulse shape. The control unit 26 shapes the inspection laser light Ld so that the inspection laser light Ld has the same pulse width and repetition frequency as the processing laser light Lw and the output periods thereof do not overlap each other (so that the pulse of the inspection laser light Ld and the pulse of the processing laser light Lw do not overlap each other), for example, as shown in FIG. 7. The control unit 26 generates information indicating the output periods of the processing laser light Lw and the inspection laser light Ld, and outputs it to the calculation unit 6. The calculation unit 6 calculates the surface roughness of the object S on the basis of a ratio between the intensity of the regular reflection light Lr detected by the first detection unit 4 during a period T in which the surface Sa of the object S is not irradiated with the processing laser light Lw, and the intensity of the scattered light Ls detected by the second detection unit 5 during the same period T. Note that the repetition frequencies of the inspection laser light Ld and the processing laser light Lw may be different from each other. For example, by making the repetition frequency of the processing laser light Lw higher than the repetition frequency of the inspection laser light Ld, the inspection laser light Ld may be output once for every multiple outputs (for example, approximately twice to 20 times) of the processing laser light Lw. In addition, the pulse widths of the inspection laser light Ld and the processing laser light Lw may be different from each other. For example, the processing laser light Lw may be output as a burst pulse having an extremely short pulse width.

Also in such a processing device 21B, similarly to the processing device 21A shown in FIG. 5, it is possible to suitably perform real-time measurement of the surface roughness of the object S in laser polishing processing. Furthermore, in the processing device 21B, the scattered light Ls reflected from the second surface 13 and directed toward the second detection unit 5 and the plasma light emission Lp which is similarly reflected by the second surface 13 and travels to the second detection unit 5 are temporally shifted from each other, and thus it is possible to prevent the plasma light emission Lp from affecting the detection of the scattered light Ls by the second detection unit 5. Thus, it is possible to more suitably perform real-time measurement of the surface roughness of the object S.

In the processing device 21B, the calculation unit 6 calculates the surface roughness of the object S on the basis of a ratio between the intensity of the regular reflection light Lr detected by the first detection unit 4 during a period T when the surface Sa of the object S is not irradiated with the processing laser light Lw, and the intensity of the scattered light Ls detected by the second detection unit 5 during the same period T. Thereby, it is possible to eliminate the influence of the plasma light emission Lp caused by the processing laser light Lw when calculating the surface roughness of the object S, thereby improving the measurement accuracy of the surface roughness.

The configuration of the optical system in the processing device 21B is not limited to the example shown in FIG. 6, and other configurations may be adopted. For example, a configuration may be adopted in which the optical path of the regular reflection light Lr directed toward the first detection unit 4 through the through hole 14 from the second surface 13 side is separated from the optical path of the processing laser light Lw directed toward the object S. For example, a half mirror can be used to separate the optical path of the regular reflection light Lr from the processing laser light Lw. In this case, even when the processing laser light Lw and the inspection laser light Ld are coaxial, it is possible to prevent the regular reflection light of the processing laser light Lw from traveling to the first detection unit 4.

Furthermore, in the processing device 21B, instead of the mechanical shutter, a configuration may be adopted in which the timing of reading data from the first detection unit 4 and the second detection unit 5 is shifted from the timing of irradiation with the processing laser light Lw. A configuration in which the timing of reading data is shifted from the timing of irradiation with the processing laser light Lw may be used in combination with the mechanical shutter.

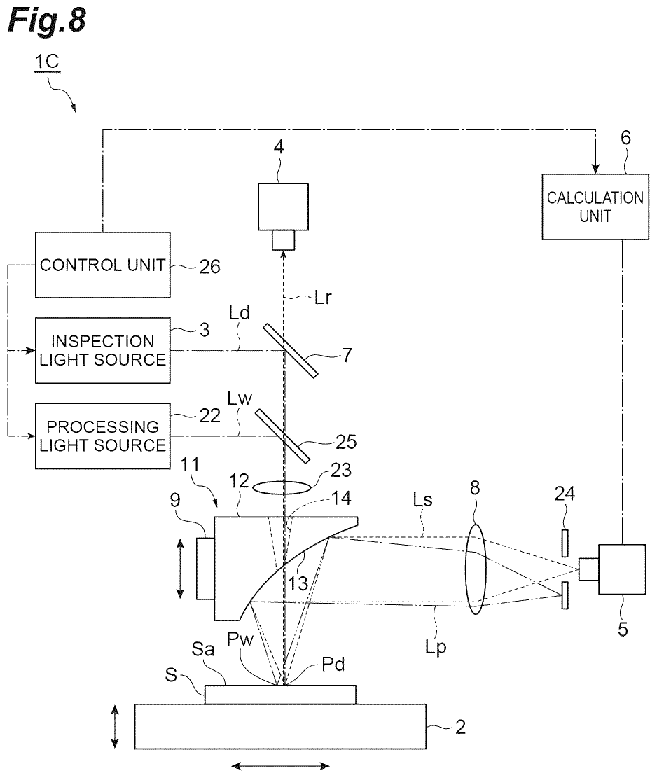

FIG. 8 is a schematic diagram showing another example of the configuration of a processing device. A processing device 21C shown in FIG. 8 differs from the processing device shown in FIG. 6 in that the processing laser light Lw and the inspection laser light Ld directed toward the object S are non-coaxial, and the control unit 26 shown in FIG. 6 is further provided. In the example of FIG. 8, the processing laser light Lw output from the processing light source 22 and the inspection laser light Ld output from the inspection light source 3 pass through the through hole 14 of the off-axis parabolic mirror element 11 from the first surface 12 side in a spatially shifted state and travel to the surface Sa of the object S placed on the stage 2. As in the case of FIG. 5, a spatial shift amount here is preferably a shift amount such that an irradiation spot of the processing laser light Lw and an irradiation spot of the inspection laser light Ld do not overlap each other on the surface Sa of the object S.

According to such a processing device 21C, as in the case of FIG. 5, the plasma light emission Lp that is spatially separated from the scattered light Ls can be blocked by the aperture 24 before the second detection unit 5. In addition, as in the case of FIG. 6, the surface roughness of the object S can be calculated on the basis of a ratio between the intensity of the regular reflection light Lr detected by the first detection unit 4 during a period T when the surface Sa of the object S is not irradiated with the processing laser light Lw, and the intensity of the scattered light Ls detected by the second detection unit 5 during the same period T. Thus, when calculating the surface roughness of the object S, the influence of the plasma light emission Lp caused by the processing laser light Lw can be eliminated, thereby improving the measurement accuracy of the surface roughness.

The present disclosure is not limited to the above embodiment. For example, in the above embodiment, a single through hole 14 is provided in the off-axis parabolic mirror element 11, but a plurality of through holes 14 may be provided in the off-axis parabolic mirror element 11. In this case, for example, one through hole 14 is formed to be inclined to the normal direction of the first surface 12, and the other through hole 14 is formed to be inclined to the opposite side to the one through hole 14 with respect to the normal direction of the first surface 12. Then, the inspection laser light Ld is caused to travel from the first surface 12 side to the second surface 13 side through one through hole 14, and the regular reflection light Lr is caused to travel from the second surface 13 side to the first surface 12 side through the other through hole 14. Even with such a configuration, as in the above embodiment, it is possible to suitably perform real-time measurement of the surface roughness of an object in laser polishing processing.

### REFERENCE SIGNS LIST

1 Measurement device, 2 Stage (adjustment mechanism), 3 Inspection light source, 4 First detection unit, 5 Second detection unit, 6 Calculation unit, 7 Half mirror, 8 Condenser lens, 9 Holding unit (adjustment mechanism), 11 Off-axis parabolic mirror element, 12 First surface, 13 Second surface, 14 Through hole, 21A to 21C Processing device, 22 Processing light source, 24 Aperture, Ld Inspection laser light, Lw Processing laser light, Lr Regular reflection light, Ls Scattered light, Lp Plasma emission, S Object, Sa Surface, Pd Irradiation position of inspection laser light (measurement point), Pw Irradiation position of processing laser light, T Period in which surface of object is not irradiated with processing laser light

1. A measurement device that measures surface roughness of an object, the measurement device comprising:
an inspection light source that outputs inspection laser light to a surface of the object;
a first detector that detects regular reflection light of the inspection laser light from a measurement point on the surface of the object;
a second detector that detects scattered light of the inspection laser light from the measurement point on the surface of the object; and
an off-axis parabolic mirror element that includes a first surface, a second surface configured with a concave parabolic mirror surface and positioned on a side opposite to the first surface, and a through hole connecting the first surface and the second surface,
wherein the off-axis parabolic mirror element is disposed such that the inspection laser light from the inspection light source travels from the first surface side through the through hole to the object, the regular reflection light having passed through the through hole from the second surface side travels to the first detector, and the scattered light reflected by the second surface travels to the second detector.

2. The measurement device according to claim 1, further comprising a calculator that calculates a surface roughness of the object on the basis of a ratio between an intensity of the regular reflection light detected by the first detector and an intensity of the scattered light detected by the second detector.

3. The measurement device according to claim 1, wherein the off-axis parabolic mirror element is disposed such that the inspection laser light from the inspection light source travels perpendicular to the surface of the object through the through hole from the first surface side.

4. The measurement device according to claim 1, wherein the through hole becomes gradually narrower from the first surface side toward the second surface side.

5. The measurement device according to claim 1, further comprising a condenser lens that is disposed in an optical path of the scattered light between the second surface and the second detector.

6. The measurement device according to claim 1, further comprising a half mirror that shares a portion of an optical path of the inspection laser light between the inspection light source and the first surface, and a portion of an optical path of the regular reflection light between the first surface and the first detector.

7. The measurement device according to claim 1, further comprising an adjuster that relatively adjusts a positional relationship between the object and the off-axis parabolic mirror element in a traveling direction of the inspection laser light directed toward the object through the through hole from the first surface side.

8. The measurement device according to claim 7, wherein the adjuster is configured with a holder that holds the off-axis parabolic mirror element movably in a traveling direction of the inspection laser light directed toward the object through the through hole from the first surface side.

9. The measurement device according to claim 7, wherein the adjuster is configured with a stage that holds the object movably in a traveling direction of the inspection laser light directed toward the object through the through hole from the first surface side.

10. The measurement device according to claim 1, wherein the first detector and the second detector are configured with a single-channel photodetector.

11. A measurement method for measuring surface roughness of an object, the measurement method comprising:
outputting inspection laser light to a surface of the object; and
detecting regular reflection light of the inspection laser light from a measurement point on the surface of the object by a first detector and detecting scattered light of the inspection laser light from the measurement point on the surface of the object by a second detector.
wherein, in the output and the detection
an off-axis parabolic mirror element including a first surface, a second surface configured with a concave parabolic mirror surface and positioned on a side opposite to the first surface, and a through hole connecting the first surface and the second surface is used, and
the off-axis parabolic mirror element is disposed such that the inspection laser light travels from the first surface side through the through hole to the object, the regular reflection light having passed through the through hole from the second surface side travels to the first detector, and the scattered light reflected by the second surface travels to the second detector unit.

12. A processing device that processes a surface of an object, the processing device comprising:
a processing light source that outputs processing laser light to the surface of the object; and
the measurement device according to claim 1.

13. The processing device according to claim 12, further comprising a calculator that calculates a surface roughness of the object on the basis of a ratio between an intensity of the regular reflection light detected by the first detector and an intensity of the scattered light detected by the second detector.

14. The processing device according to claim 12, further comprising a stage that holds the object movably in a traveling direction of the inspection laser light directed toward the object through the through hole from the first surface side and in an in-plane direction of the surface of the object.

15. The processing device according to claim 12, wherein an irradiation position of the inspection laser light is shifted from an irradiation position of the processing laser light on the surface of the object.

16. The processing device according to claim 15, further comprising an aperture that transmits only the scattered light and is disposed in an optical path of the scattered light between the second surface and the second detector.

17. The processing device according to claim 13, further comprising a controller that controls the processing light source and the inspection light source so that the surface of the object is irradiated with the processing laser light and the inspection laser light during different output periods.

18. The processing device according to claim 17, wherein the calculator calculates a surface roughness of the object on the basis of a ratio between an intensity of the regular reflection light detected by the first detector during a period in which the surface of the object is not irradiated with the processing laser light and an intensity of the scattered light detected by the second detector during the same period.
